(19) United States
(12) Patent Application Publication
(10) Pub. No.: US 2015/0077861 A1
(43) Pub. Date: Mar. 19, 2015

(54) FIVE-PIECE WIDE-ANGLE LENS MODULE

(71) Applicant: Kinko-Optical Co., Ltd., Taichung City (TW)

(72) Inventors: Yi-Zhi LIN, Taichung City (TW); Sze-Ying CHEN, Taichung City (TW); Yi-Fang CHEN, Taichung City (TW)

(73) Assignee: Kinko-Optical Co., Ltd., Taichung City (TW)

(21) Appl. No.: 14/134,034

(22) Filed: Dec. 19, 2013

(30) Foreign Application Priority Data
Sep. 16, 2013 (TW) 102133558

(51) Int. Cl. G02B 13/18

(52) U.S. Cl. CPC G02B 13/18
USPC 359/714

(57) ABSTRACT

A five-piece wide-angle lens module includes a first lens, a second lens, a third lens, a stop, a fourth lens and a fifth lens, which are sequentially arranged from an object side to an image side. The first lens has a negative refractive power, a convex surface on the object side, and a concave surface on the image side. The second lens has a negative refractive power and two concave surfaces on both sides respectively. The third lens has a positive refractive power. The fourth lens has a positive refractive power and two convex surfaces on both sides respectively. The fifth lens has a negative refractive power. To provide good image quality, the five-piece wide-angle lens module satisfies the following relationships: −0.6<f₂/f₃<−0.3, and −0.25<f₄/f₅<−0.15.

### BACKGROUND OF THE INVENTION

1. Field of the Invention

The present invention relates generally to an optical system, and more particularly to a five-piece wide-angle lens module.

2. Description of the Related Art

When a driver backs a car, he or she usually relies on the rear-view mirror and the side-view mirrors to see the road behind the car. However, the driver is still unable to see somewhere behind the car, which is called the “blind zone”. Therefore, rear-view video cameras are installed on vehicles to assist the driver to have better rear visibility and the wider field of view.

In some areas having obvious season changes, the temperature can go down to −20° C. or lower in winter and up to 60° C. or higher in summer. Therefore, the rear-view video cameras must have excellent and consistent imaging quality in high/low temperature environment, otherwise the rear-view video cameras can be unsatisfying.

### SUMMARY OF THE INVENTION

It is a main objective of the present invention to provide an optical system which can provide excellent imaging quality in both high and low temperature environments.

It is another main objective of the present invention to provide a wide-angle optical system.

To achieve the above and other objectives of the present invention, a five-piece wide-angle lens is provided, in which the lens includes in a sequence from an object side to an image side of a first lens, a second lens, a third lens, a stop, a fourth lens, and a fifth lens. The first lens has a negative refractive power, a convex surface on the object side, and a concave surface on the image side. The second lens has a negative refractive power and two concave surfaces on both the object side and the image side respectively. The third lens has a positive refractive power. The fourth lens has a positive refractive power and two convex surfaces on both the object side and the image side respectively. The fifth lens has a negative refractive power. Each of the second lens, the third lens, the fourth lens and the fifth lens has at least one aspheric surface. The five-piece wide-angle lens module satisfies the following relationships: −0.6<f₂/f₃<−0.3, and −0.25<f₄/f₅<−0.15, in which f₂ is a focal length of the second lens, f₃ is a focal length of the third lens, f₄ is a focal length of the fourth lens, and f₅ is a focal length of the fifth lens.

When the five-piece wide-angle lens satisfies the above-mentioned relationships, they can have a good refractive configuration. Thus the optical aberration of the wide-angle system can be modified, and the five-piece wide-angle lens module can still have excellent image quality in the severe environment (e.g. temperature ranging from −50° C. to 100° C.).

The following detailed description will further explain the full scope of applications for the present invention. However, it should be understood that the detailed description and specific examples, while indicating preferred embodiments of the invention, are given by way of illustration only, since various changes and modifications within the spirit and scope of the invention will become apparent to those with the proper technical knowledge from this detailed description.

### BRIEF DESCRIPTION OF THE DRAWINGS

The present invention can be understood more fully by referring to the detailed description below, as well as the accompanying drawings. However, it must be understood that both the descriptions and drawings are given by way of illustration only, and thus do not limit the present invention.

FIG. 1 is a schematic view of a lens module in accordance with the first embodiment of the present invention;

FIG. 2 is a diagram showing the optical aberration of the lens module in accordance with the first embodiment of the present invention at 25° C.;

FIG. 3 is a diagram showing the optical aberration of the lens module in accordance with the first embodiment of the present invention at −50° C.;

FIG. 4 is a diagram showing the optical aberration of the lens module in accordance with the first embodiment of the present invention at 100° C.;

FIG. 5 is a diagram showing the field curvature and the distortion of the lens module in accordance with the first embodiment of the present invention;

FIG. 6 is a diagram showing the lateral color aberration of a lens module in accordance with the first embodiment of the present invention;

FIG. 7 is a schematic view of a lens module in accordance with the second embodiment of the present invention;

FIG. 8 is a diagram showing the optical aberration of the lens module in accordance with the second embodiment of the present invention at 25° C.;

FIG. 9 is a diagram showing the optical aberration of the lens module in accordance with the second embodiment of the present invention at −50° C.;

FIG. 10 is a diagram showing the optical aberration of the lens module in accordance with the second embodiment of the present invention at 100° C.;

FIG. 11 is a diagram showing the field curvature and the distortion of the lens module in accordance with the second embodiment of the present invention;

FIG. 12 is a diagram showing the lateral color aberration of a lens module in accordance with the second embodiment of the present invention.

### DETAILED DESCRIPTION OF THE INVENTION

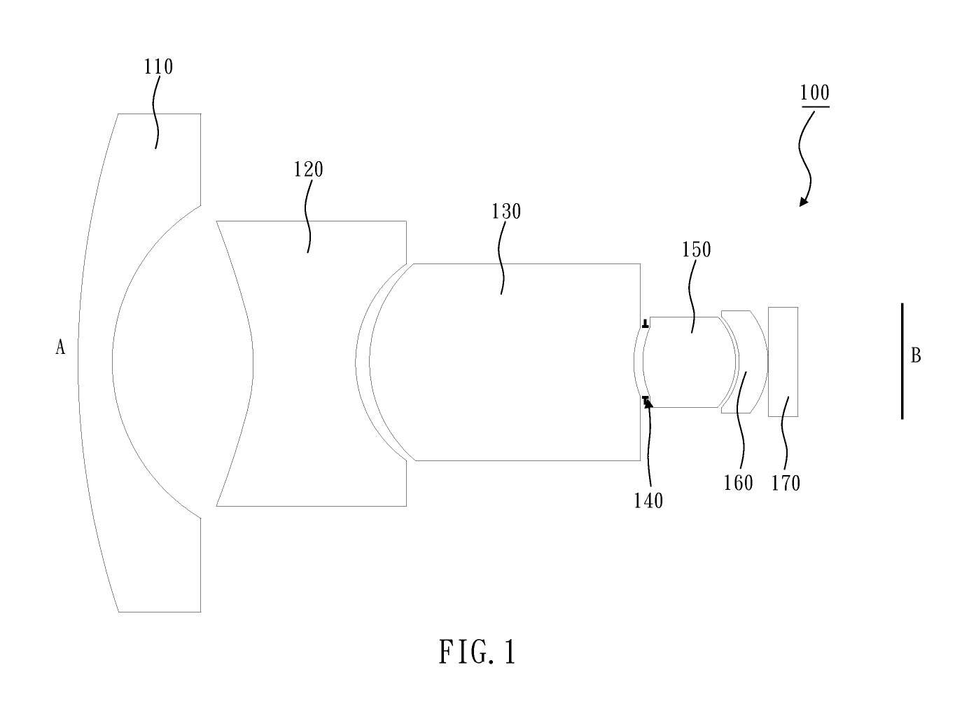

Please refer to FIG. 1 for a five-piece wide-angle lens module in accordance with the first embodiment of the present invention. The lens module 100 includes in a sequence from an object side A to an image side B of: a first lens 110, a second lens 120, a third lens 130, a stop 140, a fourth lens 150, and a fifth lens 160. CCD, CMOS or other image sensor can be disposed at the image side B. One or more plate glasses 170 such as an optical filter and/or a protection glass can be additionally disposed between the image sensor and the fifth lens 160, in which the amount of the plate glass 170 can be adjusted subject to the requirements.

The first lens 110 is a meniscus lens with a negative power and has a convex surface on the object side and a concave surface on the image side so as to provide the wide angle characteristic.

The second lens 120 also has a negative refractive power and shares the refractive power loading with the first lens 110, such that the system aberration can be controlled. Both the object side and the image side of the second lens 120 are concave surfaces, which can lead to modification of aberration caused by marginal rays.

The third lens 130 has a positive refractive power to balance out the negative refractive power of the first and second lenses 110 and 120 in order to further modify the aberration. The object side of the third lens 130 is a convex surface, and the image side thereof is a concave surface.

The stop 140 is designed to locate between the third lens 130 and the fourth lens 150. Such arrangement is helpful to balance out the system refractive power and efficiently reduce the system sensitivity.

The fourth lens 150 has a positive refractive power and two convex surfaces on both the object side and the image side.

The fifth lens 160 has a negative refractive power, a concave surface on the object side and a convex surface on the image side.

The optical feature data of the five-piece wide-angle lens module 100 in accordance with the first embodiment are listed in Table 1:

TABLE 1

| Lens | Surface | Radius | Thickness | Nd | Vd | Conic |
|---|---|---|---|---|---|---|
| Object | | ∞ | ∞ | | | 0 |
| First | Object surface 1 | 25 | 1 | 1.834 | 42.7 | 0 |
| lens | Image surface 2 | 5.5 | 4.225 | | | 0 |
| Second | Object surface 3 | −4.4 | 3.1 | 1.53 | 56.1 | −6.67 |
| lens | Image surface 4 | 4.92 | 0.39 | | | 0.97 |
| Third | Object surface 5 | 4.55 | 8 | 1.64 | 23.5 | −0.87 |
| lens | Image surface 6 | 4.15 | 0.3 | | | −38.17 |
| Stop | | ∞ | −0.168 | | | 0 |
| Fourth | Object surface 8 | 2.6 | 2.8 | 1.53 | 56.1 | −11.16 |
| lens | Image surface 9 | −1.47 | 0.1 | | | −0.57 |
| Fifth | Object surface 10 | −1.65 | 0.8 | 1.64 | 23.5 | −0.55 |
| lens | Image surface 11 | −2.4 | 0.05 | | | −8.69 |
| Plate | Object surface 12 | ∞ | 0.9 | 1.52 | 64.1 | 0 |
| glass | Image surface 13 | ∞ | 3.27 | | | 0 |
| Image | | ∞ | | | | 0 |

All the object sides and the image sides of the second lens 120, the third lens 130, the fourth lens 150 and the fifth lens 160 are aspheric surfaces, whose shapes satisfy the following formula:

$$z = \frac{{ch}^{2}}{1 + {[ 1 - ( k + 1 ) {c}^{2} {h}^{2} ]}^{\frac{1}{2}}} + {Ah}^{4} + {Bh}^{6} + {Ch}^{8} + {Dh}^{10} + {Eh}^{12} + {Fh}^{14} + {Gh}^{16}$$

wherein z is a value of a reference position with respect to a vertex of the surface along an optical axis of the lens module at a position with a height h, c is a reciprocal of a radius of curvature of the surface, k is a conic constant, A is a coefficient of fourth level aspheric surface, B is a coefficient of sixth level aspheric surface, C is a coefficient of eighth level aspheric surface, D is a coefficient of tenth level aspheric surface, E is a coefficient of twelfth level aspheric surface, F is a coefficient of fourteenth level aspheric surface, and G is a coefficient of sixteenth level aspheric surface.

The coefficients of the aspheric surface of the second lens 120 to the fifth lens 160 in the present embodiment are listed in Table 2:

TABLE 2

| | Object surface 3 | Image surface 4 | Object surface 5 | Image surface 6 |
|---|---|---|---|---|
| A | 0.0010963265 | 0.022099817 | 0.012841651 | 0.040596125 |
| B | −3.0299061e−005 | −0.0022800517 | −0.0014392631 | 0.017826591 |
| C | −4.4873152e−006 | −3.4888069e−005 | 5.944269e−005 | −0.0091502209 |
| D | 2.5440967e−007 | 1.8727775e−005 | 5.22602e−006 | 0.00071855887 |
| E | −3.5544596e−009 | −1.1285088e−006 | −5.1219614e−007 | 0.002294535 |
| F | 0 | 0 | 0 | 0 |
| G | 0 | 0 | 0 | 0 |
| | Object surface 8 | Image surface 9 | Object surface 10 | Image surface 11 |
| A | 0.041539684 | 0.0015924177 | −0.019767887 | −0.0692465 |
| B | 0.014245223 | 0.032582198 | 0.035192349 | 0.026160088 |
| C | −0.019099719 | −0.0087874901 | −0.0031484984 | −0.0042433034 |
| D | 0.0076090621 | 0.00048587656 | −0.0019634767 | 7.2802262e−006 |
| E | −0.0001419018 | −8.2859808e−006 | −4.076445e−005 | 3.6374827e−005 |
| F | 0 | 0 | 0 | 0 |
| G | 0 | 0 | 0 | 0 |

Based on the afore-mentioned design, the total focal length f of the present embodiment is 1.22 mm, the total length thereof is 24.8 mm, the angle of view is 166 degrees, the focal length of the first lens 110 is −8.6 mm, the focal length of the second lens 120 is −3.9 mm, the focal length of the third lens 130 is 10.67 mm, the focal length of the fourth lens 150 is 2.3 mm, and the focal length of the fifth lens 160 is −14.06 mm.

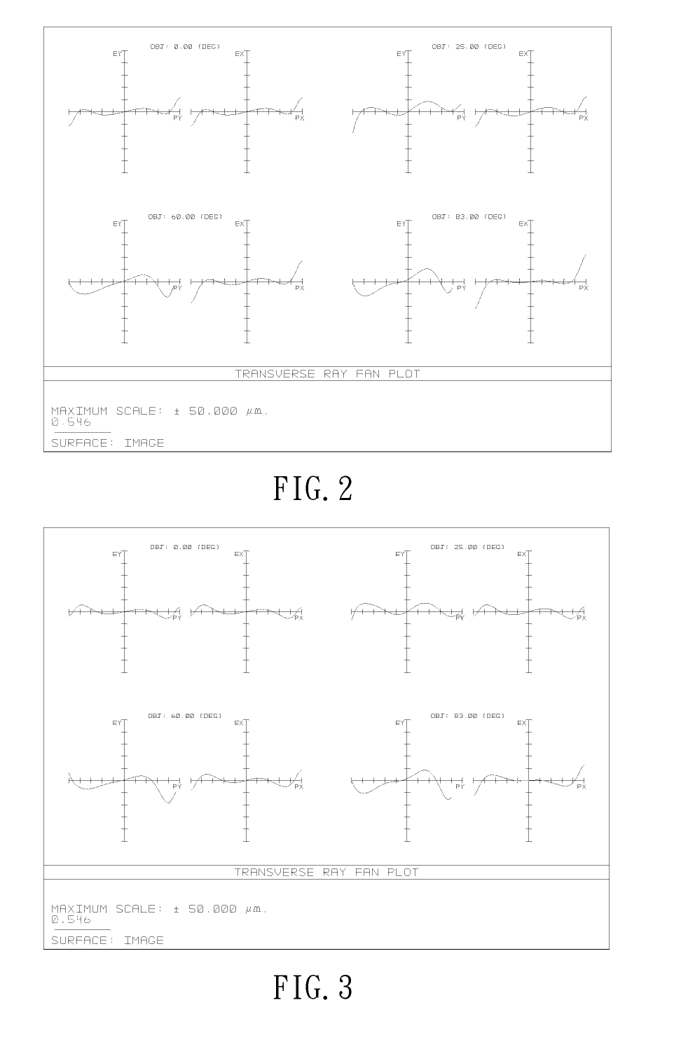

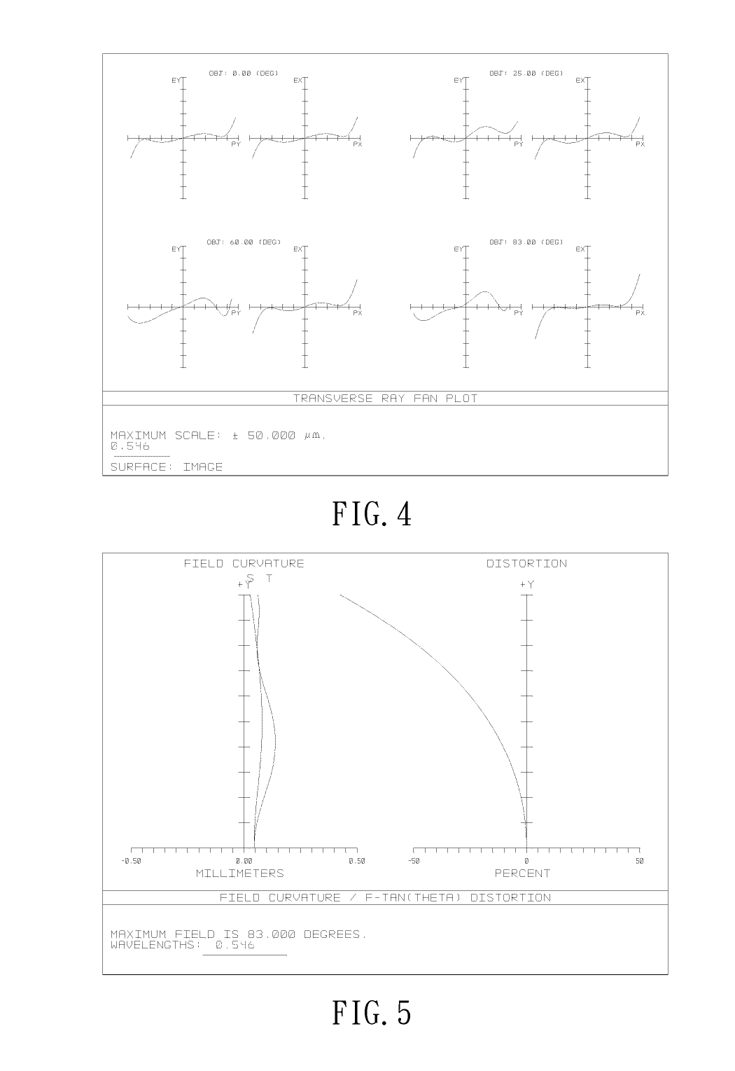

The ratio of the focal length of the second lens 120 to that of the third lens 130 (f₂/f₃) is −0.37, and the ratio of the focal length of the fourth lens 150 to that of the fifth lens 160 (f₄/f₅) is −0.16. These ratios satisfy the relationships of −0.6<f₂/f₃<−0.3 and −0.25<f₄/f₅<−0.15. Therefore, the system has a good refractive power arrangement and can effectively modify the aberration of the wide-angle system. Such arrangement also enables the lens module 100 to have excellent and consistent image quality in the environment having severe temperature changes. Test results of which are shown in FIGS. 2-5.

In addition, the focal lengths of the first lens 110 and the second lens 120 also need to coordinate with each other. The ratio of the focal length thereof preferably satisfies the following relationship: 1.6<f₁/f₂<2.9, in which f₁ is the focal length of the first lens 110. In the present embodiment, f₁/f₂ is 2.2 and satisfies the above-mentioned relationship. Therefore, the second lens 120 shares the negative refractive power of the first lens 110 in order to reduce the system aberration.

Since the image surface of the first lens 110 is a concave surface, and the object surface of the second lens 120 is also a concave surface, the radii of curvature thereof need to coordinate with each other, preferably satisfying the following relationship: 8<(r₂−r₃)/(r₂+r₃)<22, in which r₂ is the radius of curvature of the image surface of the first lens 110, and r₃ is the radius of curvature of the object surface of the second lens 120. In the present embodiment, (r₂−r₃)/(r₂+r₃) is 9, which satisfies the above-mentioned relationship, and therefore the system aberration can be modified.

Moreover, since the object-sided surface and the image-sided surface of the fourth lens 150 are both convex, the radii of curvature thereof also need to coordinate with each other, preferably satisfying the following relationship: 2<(r₈−r₉)/(r₈+r₉)<4.2, in which r₈ is the radius of curvature of the object surface of the fourth lens 150, and r₉ is the radius of curvature of the image surface of the fourth lens 150. In the present embodiment, (r₈−r₉)/(r₈+r₉) is 3.6, which satisfies the above-mentioned relationship, and therefore an incident angle of a ray incident from the stop 140 to the fourth lens 150 is smaller, which is helpful to reduce the system sensitivity.

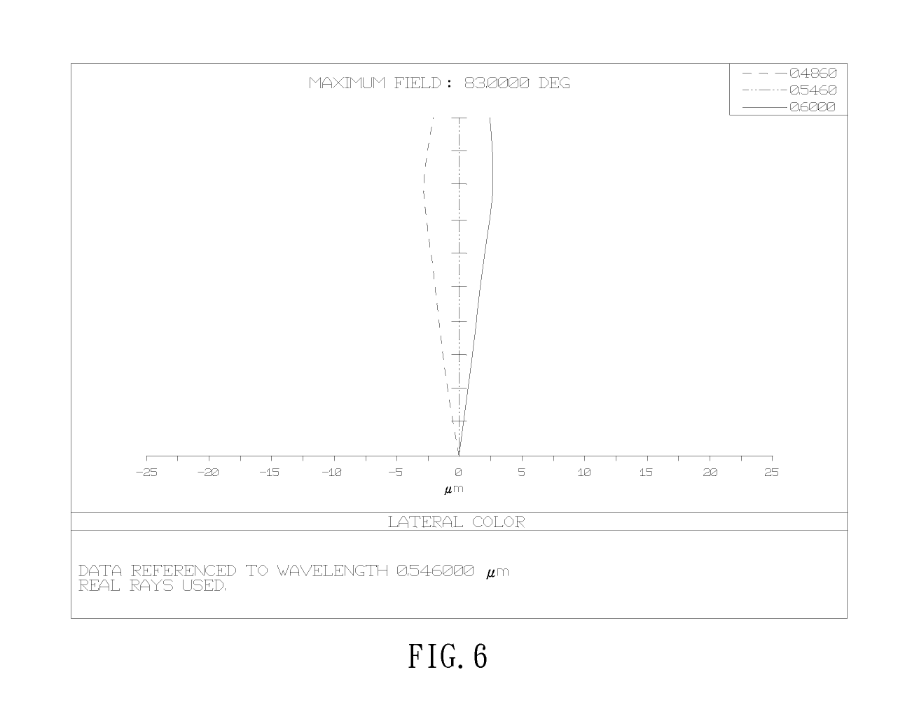

To mitigate the problem that a wide-angle system tends to have lateral color aberration, the Abbe numbers of the fourth lens 150 and the fifth lens 160 need to coordinate with each other, preferably satisfying the following relationship: Vd₄−Vd₅>25, in which Vd₄ is the Abbe number of the fourth lens 150, and Vd₅ is the Abbe number of the fifth lens 160. In the present embodiment, Vd₄−Vd₅ is 32.6, which satisfies the above-mentioned relationship, and therefore the lateral color aberration can be modified. A test result of which is shown in FIG. 6.

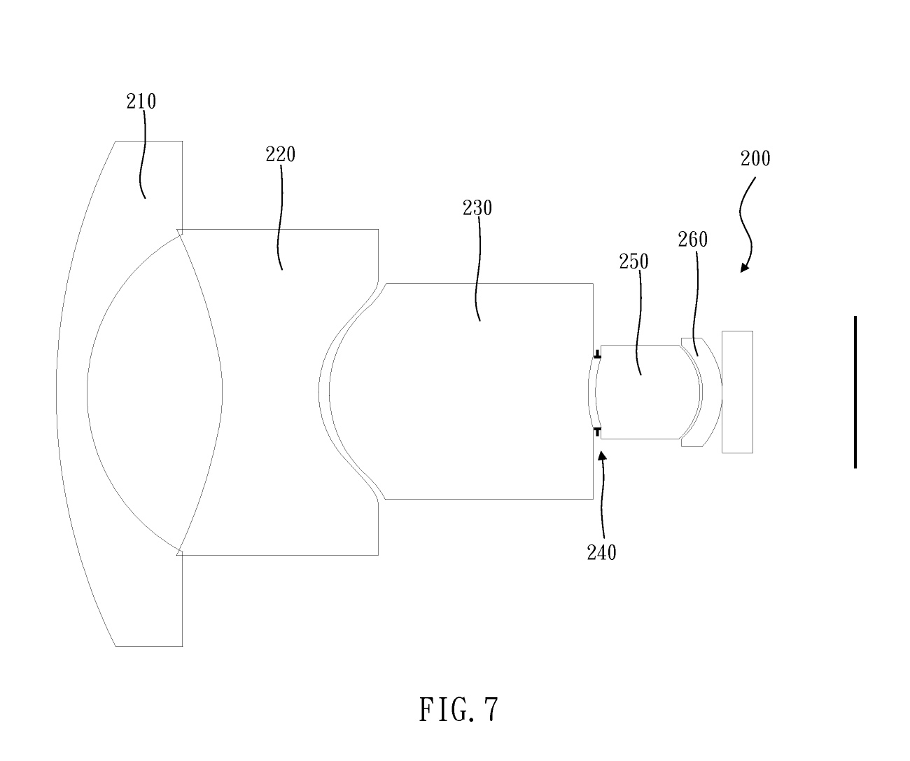

Please refer to FIG. 7 for a five-piece wide-angle lens module 200 in accordance with the second embodiment of the present invention. The structural arrangement of the second embodiment is similar to that of the first embodiment, and the optical feature data thereof are listed in Table 3:

TABLE 3

| Lens | Surface | Radius | Thickness | Nd | Vd | Conic |
|---|---|---|---|---|---|---|
| Object | | ∞ | ∞ | | | 0 |
| First lens | Object surface 1 | 18 | 1 | 1.834 | 42.7 | 0 |
| | Image surface 2 | 5.75 | 4.29 | | | 0 |
| Second lens | Object surface 3 | −5.22 | 3.08 | 1.53 | 56.1 | −6.245 |
| | Image surface 4 | 4.08 | 0.33 | | | 0.125 |
| Third lens | Object surface 5 | 4 | 8.27 | 1.64 | 23.5 | −1.041 |
| | Image surface 6 | 5.7 | 0.235 | | | −23.52 |
| Stop | | ∞ | −0.147 | | | 0 |
| Fourth lens | Object surface 8 | 3.52 | 3.37 | 1.53 | 56.1 | 6.284 |
| | Image surface 9 | −1.42 | 0.07 | | | −1.478 |
| Fifth lens | Object surface 10 | −1.58 | 0.63 | 1.64 | 23.5 | −1.07 |
| | Image surface 11 | −2.3 | 0.05 | | | −2.774 |
| Plate glass | Object surface 12 | ∞ | 0.9 | 1.52 | 64.1 | 0 |
| | Image surface 13 | ∞ | 3.42 | | | 0 |
| Image | | ∞ | | | | 0 |

Likewise, all the object sides and the image sides of the second lens 220, the third lens 230, the fourth lens 250 and the fifth lens 260 are aspheric surfaces and satisfy the above-mentioned shape formula, the coefficients of the aspheric surface thereof are listed in Table 4:

TABLE 4

| | Object surface 3 | Image surface 4 | Object surface 5 | Image surface 6 |
|---|---|---|---|---|
| A | 0.00094198026 | 0.014897377 | 0.0087719657 | 0.054573334 |
| B | −5.1966273e−005 | −0.0013911648 | −0.00042873058 | 0.0077799809 |
| C | 6.6589612e−007 | 9.8304251e−006 | −2.4132455e−006 | −0.003256489 |
| D | 9.1307441e−009 | −2.3053745e−007 | −6.9203833e−008 | −0.00060016498 |
| E | −2.2637996e−010 | −3.8091874e−008 | −5.7609957e−008 | −0.0012027896 |
| F | 0 | 0 | 0 | 0 |
| G | 0 | 0 | 0 | 0 |
| | Object surface 8 | Image surface 9 | Object surface 10 | Image surface 11 |
| A | 0.010475574 | 0.028244503 | 0.015520676 | −0.031109108 |
| B | 0.010495202 | −0.00083714195 | 0.012002875 | 0.0099240437 |
| C | −0.020090321 | −0.00271942 | −0.0032935255 | −0.00091942668 |
| D | −0.0015571378 | 0.00017213507 | −0.00033941001 | −6.4505856e−005 |
| E | 0.0075440299 | −0.0016519109 | −0.002205681 | −0.00016946594 |
| F | −0.0045331302 | 0.00053027025 | 0.00069011378 | 4.1576431e−005 |
| G | 0 | 0 | 0 | 0 |

Based on the above-mentioned design, the total focal length f of the present embodiment is 1.39 mm, the total length thereof is 25.5 mm, the angle of view thereof is 166 degrees, the focal length of the first lens 210 is −10.45 mm, the focal length of the second lens 220 is −3.82 mm, the focal length of the third lens 230 is 7.20 mm, the focal length of the fourth lens 250 is 2.47 mm, and the focal length of the fifth lens 260 is −11.95 mm.

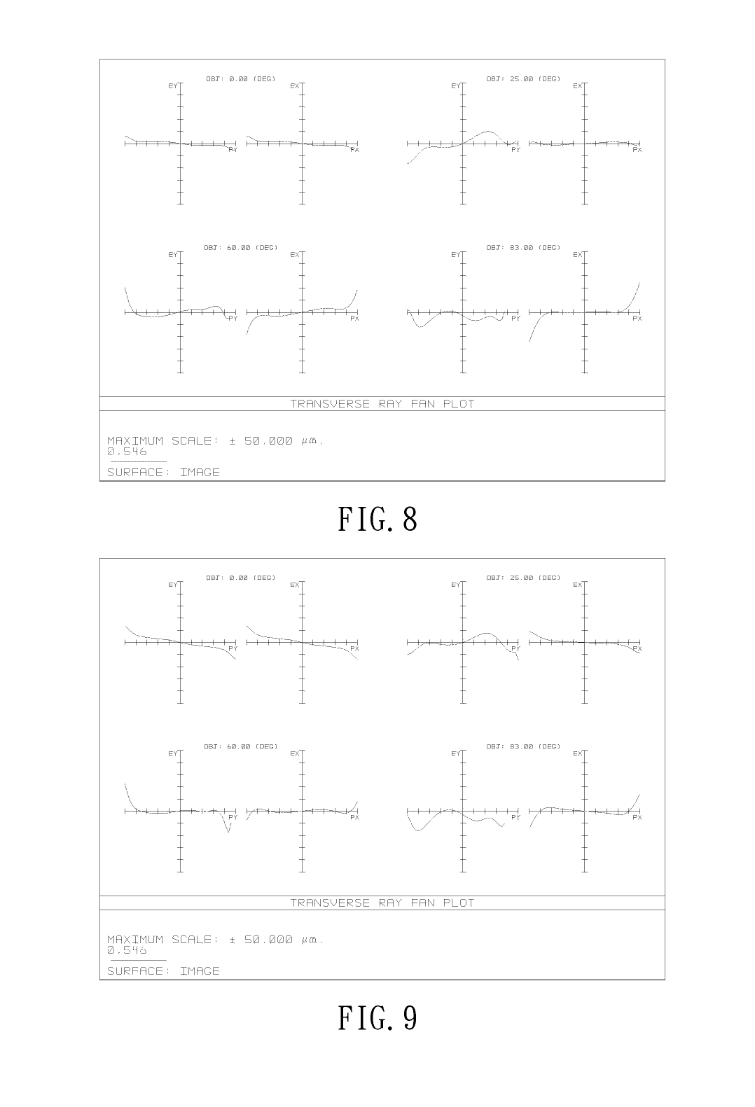

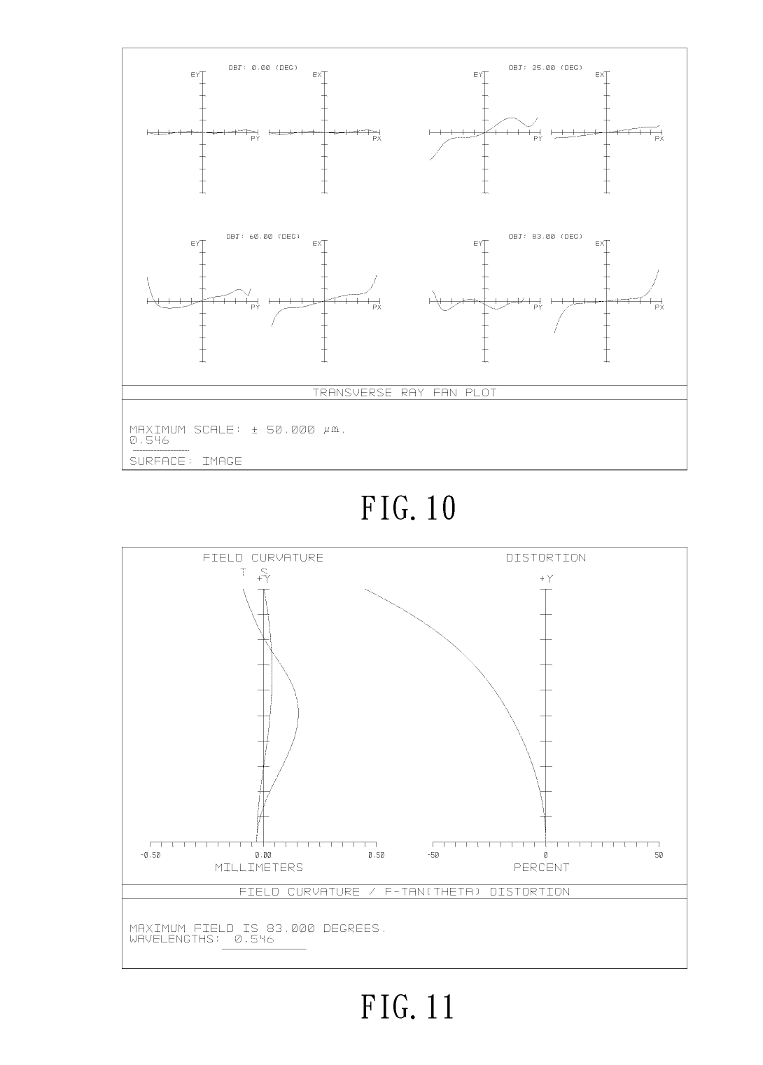

The ratio of the focal length of the second lens 220 to that of the third lens 230 (f₂/f₃) is −0.53, and the ratio of the focal length of the fourth lens 250 to that of the fifth lens 260 (f₄/f₅) is −0.21. These ratios satisfy the relationships of −0.6<f₂/f₃<−0.3 and −0.25<f₄/f₅<−0.15. Therefore, the system has a good refractive power arrangement and can effectively modify the aberration of the wide-angle system. Such arrangement also enables the lens module 200 to have excellent and consistent image quality in the environment having severe temperature changes. Test results of which are shown in FIGS. 8-11.

Furthermore, the ratio of the focal length f₁ of the first lens 210 to the focal length f₂ of the second lens 220 is 2.74, which satisfies the relationship of 1.6<f₁/f₂<2.9. Therefore, the second lens 220 shares the negative refractive power of the first lens 210 in order to reduce the system aberration.

In the present embodiment, the radius of curvature r₂ of the image surface of the first lens 210 also coordinates with the radius of curvature r₃ of the object surface of the second lens 220, in which (r₂−r₃)/(r₂+r₃) is 20.7, which satisfies the relationship of 8<(r₂−r₃)/(r₂+r₃)<22. Therefore, the system aberration can be modified.

In the present embodiment, the radius of curvature r₈ of the objet surface of the fourth lens 250 also coordinates with the radius of curvature r₉ of the image surface of the fourth lens 250, in which (r₈−r₉)/(r₈+r₉) is 2.35, which satisfies the relationship of 2<(r₈−r₉)/(r₈+r₉)<4.2. Therefore, an incident angle of a ray incident from the stop 240 to the fourth lens 250 is smaller, which is helpful to reduce the system sensitivity.

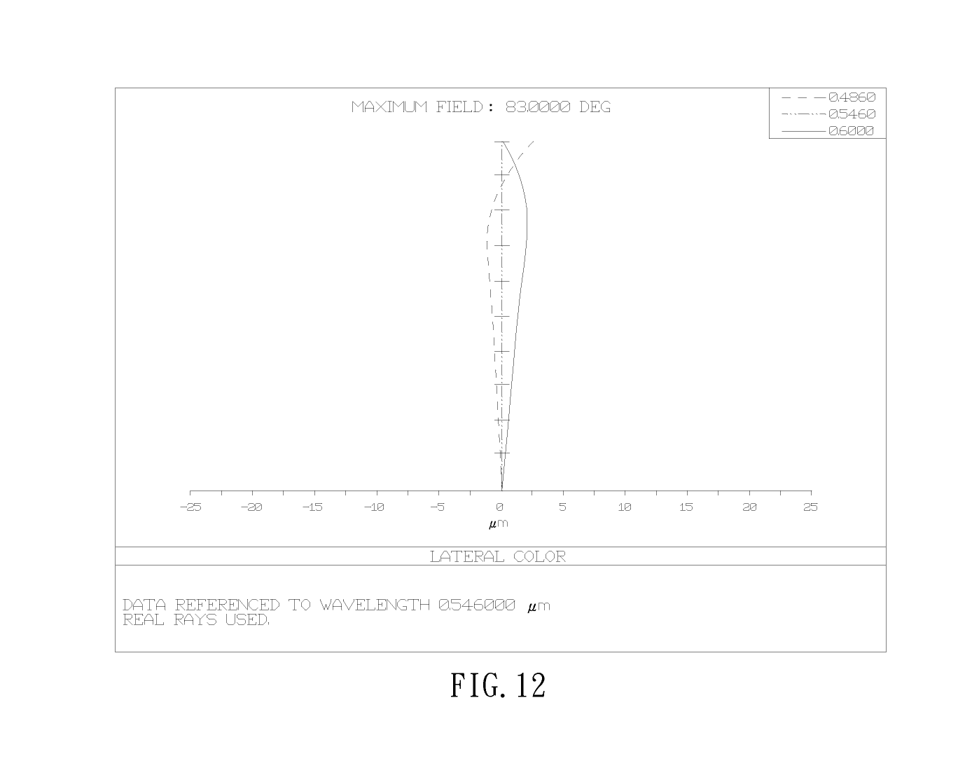

In addition, the difference between the Abbe numbers of the fourth lens 250 and the fifth lens 260, i.e. Vd₄−Vd₅, is 32.6, which satisfies the relationship of Vd₄−Vd₅>25. Therefore, the lateral color aberration can be modified. A test result of which is shown in FIG. 12.

In light of foregoing, the view of angle of the present invention can reach up to 166 degrees. Meanwhile, the image quality thereof is also significantly elevated and consistent in the environments of high temperature (100° C.) and low temperature (−50° C.). Therefore, the present invention meets the practical needs.

It is noticed that although both the object surface and the image surface of each of the second lens to the fifth lens in accordance with the above-mentioned embodiments are aspheric surfaces, each of the second lens to the fifth lens is only required to have at least one aspheric surface. And because of the aspheric surfaces, the second lens to the fifth lens are preferably made of plastic to reduce manufacturing cost and increase yield rate. The first lens is preferably made of glass that has better wear resistance and scrape resistance. However, the material of the lenses is not limited to the above-mentioned material. Furthermore, the five-piece wide-angle lens module of the present invention can not only be utilized in vehicle-use cameras but also in surveillance cameras and other purposes.

The invention described above is capable of many modifications, and may vary. Any such variations are not to be regarded as departures from the spirit of the scope of the invention, and all modifications which would be obvious to someone with the technical knowledge are intended to be included within the scope of the following claims.

What is claimed is:

1. A five-piece wide-angle lens module, comprising in a sequence from an object side to an image side of:
a first lens, having a negative refractive power, a convex surface on the object side and a concave surface on the image side;
a second lens, having a negative refractive power and two concave surfaces on the object side and the image side respectively;
a third lens, having a positive refractive power;
a stop;
a fourth lens, having a positive refractive power and two convex surfaces on the object side and the image side respectively;
a fifth lens, having a negative refractive power;
wherein each of the second lens, the third lens, the fourth lens and the fifth lens has at least one aspheric surface;
wherein the five-piece wide-angle lens module satisfies the following relationships:
−0.6<f₂/f₃<−0.3, and −0.25<f₄/f₅<−0.15;
wherein f₂ is a focal length of the second lens, f₃ is a focal length of the third lens, f₄ is a focal length of the fourth lens, and f₅ is a focal length of the fifth lens.

2. The five-piece wide-angle lens module of claim 1, further satisfying the following relationship:
Vd₄−Vd₅>25;
wherein Vd₄ is an Abbe number of the fourth lens, and Vd₅ is an Abbe number of the fifth lens.

3. The five-piece wide-angle lens module of claim 1, further satisfying the following relationship:
1.6<f₁/f₂<2.9;
wherein f₁ is a focal length of the first lens.

4. The five-piece wide-angle lens module of claim 1, further satisfying the following relationship:
8<(r₂−r₃)/(r₂+r₃)<22;
wherein r₂ is a radius of curvature of the image side of the first lens, and r₃ is a radius of curvature of the object side of the second lens.

5. The five-piece wide-angle lens module of claim 1, further satisfying the following relationship:
2<(r₈−r₉)/(r₈+r₉)<4.2;
wherein r₈ is a radius of curvature of the object side of the fourth lens, and r₉ is a radius of curvature of the image side of the fourth lens.

6. The five-piece wide-angle lens module of claim 1, wherein the first lens is a glass lens, the second lens, the third lens, the fourth lens and the fifth lens are plastic lenses.

7. The five-piece wide-angle lens module of claim 1, wherein a shape of each of the aspheric surfaces satisfies the following formula:
$$z = \frac{{ch}^{2}}{1 + {[ 1 - ( k + 1 ) {c}^{2} {h}^{2} ]}^{\frac{1}{2}}} + {Ah}^{4} + {Bh}^{6} + {Ch}^{8} + {Dh}^{10} + {Eh}^{12} + {Fh}^{14} + {Gh}^{16}$$
wherein z is a value of a reference position with respect to a vertex of the surface along an optical axis of the lens module at a position with a height h, c is a reciprocal of a radius of curvature of the surface, k is a conic constant, A is a coefficient of fourth level aspheric surface, B is a coefficient of sixth level aspheric surface, C is a coefficient of eighth level aspheric surface, D is a coefficient of tenth level aspheric surface, E is a coefficient of twelfth level aspheric surface, F is a coefficient of fourteenth level aspheric surface, and G is a coefficient of sixteenth level aspheric surface.
